(19) United States
(12) Patent Application Publication
(10) Pub. No.: US 2004/0037686 A1
(43) Pub. Date: Feb. 26, 2004

(54) Boat trailer

(76) Inventors: Ross Zietlow, Amherst, WI (US); Randy Somers, Stevens Point, WI (US)

Correspondence Address: Richard C. Litman, LITMAN LAW OFFICES, LTD., P.O. Box 15035, Arlington, VA, 22215, US

(21) Appl. No.: 10/642,665

(22) Filed: Aug. 19, 2003

Related U.S. Application Data
(60) Provisional application No. 60/405,311, filed on Aug. 23, 2002.

(51) Int. Cl. B60P 1/00

(52) U.S. Cl. 414/559

(57) ABSTRACT

A boat trailer modified to include a load-bearing trolley and a track; the trolley is movable along the track along a direction parallel to the length of the trailer, and the ends of the track correspond to the fully launched and fully loaded positions of the boat on the trailer. A belt with ends attached to the ends of the trolley is moved by a sprocket connected to a hand crank, through a set of sprockets and idler rollers. Rotating the hand crank causes the belt to move, thereby causing the trolley to move along the track, resulting in movement of the boat to either launch it into the water or load it onto the trailer. A latch mounted on a docking plate on the trolley automatically latches or releases the tow ring depending upon the position of the trolley along the track.

### CROSS-REFERENCE TO RELATED APPLICATION

This application claims the benefit of U.S. Provisional Patent Application Serial No. 60/405,311, filed Aug. 23, 2002.

### BACKGROUND OF THE INVENTION

1. Field of the Invention

The present invention relates to boat trailers and, more particularly, to an improved boat trailer in which a conventional trailer is modified to include a load-bearing trolley movable along a track for greater ease in launching or loading a boat on the trailer.

2. Description of the Related Art

Although boat trailers have been used for a long time for launching or loading boats, known trailers generally are difficult to use in launching or loading boats. For example, to load a boat onto the trailer, the trailer must be backed-up into the body of water and then a hook must be applied to the bow ring and pulled by a winch which brings the boat into place on the trailer. Hand cranked winches are difficult to operate manually, and powered winches require greater maintenance.

The instant invention is an improved boat trailer in which a conventional trailer is modified to include a load-bearing trolley movable along a track for greater ease in launching or loading a boat on the trailer. An encircling belt strip, such as a timing belt, is attached at its ends to corresponding opposite ends of the trolley. The belt strip is mounted on and is movable on a set of rollers (e.g., idlers and sprockets). One of the rollers is a hand crank that is turned manually (or, alternatively, with a 12 volt DC power winch) to transfer torque to the belt causing the trolley to move back and forth along the track, the direction of movement of the trolley depending upon the direction of rotation of the crank. A novel latch is also provided that automatically latches or releases the boat at its bow ring depending upon the position of the trolley along the track. Thus, the present invention fills the need for a boat trailer that makes loading and launching boats faster and easier than previously known trailers.

A discussion of relevant art follows.

U.S. Pat. No. 3,963,263 issued to Whitlock on Jun. 15, 1976 teaches an automatic boat latch. However, this latch does not provide an automatic release for use when launching the boat.

U.S. Pat. No. 4,363,590 issued to Crate on Dec. 14, 1982 teaches a boat trailer using a set of powered rollers for loading and launching.

U.S. Pat. No. 4,681,334 issued to O'Brien, Jr. on Jul. 21, 1987 teaches a boat trailer having a telescoping stern attachment to permit easier boat launches and loadings.

U.S. Pat. No. 4,781,392 issued to Cooper on Nov. 1, 1988 teaches a molded boat trailer in which the shape of the trailer conforms to the shape of the boat hull.

U.S. Pat. No. 5,273,391 issued to White on Dec. 28, 1993 teaches a boat trailer including a hand-cranked bow winch.

U.S. Pat. No. 5,320,058 issued to Reed on Jun. 14, 1994 teaches a boat trailer including a winch that uses an air compressor to assist in loading the boat.

U.S. Pat. No. 5,511,928 issued to Ellis on Apr. 30, 1996 teaches a boat loading device that is usable on a trailer or truck bed and includes a movable load-bearing frame. The bow ring is grasped with a hook at the end of a cable connected to a winch to pull the boat onto the frame.

U.S. Pat. No. 5,666,901 issued to Jones on Sep. 16, 1997 teaches a bow mounted boat latching mechanism in which the latch can be released by an occupant on the boat.

U.S. Pat. No. 5,879,114 issued to Spence on Mar. 9, 1999 teaches a boat-to-trailer latch which uses a spring-loaded bolt latch.

U.S. Pat. No. 5,895,066 issued to Headlee on Apr. 20, 1999 teaches a boat trailer that is connected to the vehicle hitch by a telescoping tongue that also includes a latching mechanism and a locking dog.

U.S. Pat. No. 6,135,481 issued to Bishop, III et al. on Oct. 24, 2000 teaches a boat trailer in which a support mechanism is provided on either the port or starboard sides of the trailer to securely hold the boat in place or release the boat when launching.

None of the above inventions and patents, taken either singly or in combination, is seen to describe the instant invention as claimed. Thus an improved boat trailer solving the aforementioned problems is desired.

### SUMMARY OF THE INVENTION

The present invention is directed to a modified boat trailer, particularly, in which a load-bearing trolley that supports the boat is movable back-and-forth along a track integrally attached to the trailer. An encircling strip, e.g., a strip of a timing belt, is attached to the trolley with its two ends attached to the corresponding ends of the trolley. The strip encircles a set of rollers, e.g., sprockets, and a hand crank that can be turned manually (or with a 12 volt DC power winch) to cause the belt to move and, therefore, to cause the trolley to move back-and-forth along the track.

When the trailer is fully unloaded, i.e., when preparing the trailer to load the boat from the water, the trolley is positioned at the stern of the trailer, i.e., it is positioned at the stern end of the track. In this position, the trolley is ready to receive the boat. Conversely, when the trailer is fully loaded, the front of the boat rests on the trolley and the trolley is positioned toward the front of the trailer.

The trolley includes a latch at its front end that connects to the bow ring of the boat to secure it on the trolley. The latch automatically latches onto the bow ring when the boat is being loaded onto the trolley. A docking plate that is fastened to the front of the trolley ensures that the bow ring centers onto the latch when the boat impinges on the trolley, which occurs at a speed typically about 1-3 knots. It also automatically releases the bow ring when the boat is being launched into a body of water.

Accordingly, it is a principal object of the invention to provide a boat trailer modified to include a load-bearing trolley that is movable along a track mounted on the trailer.

It is another object of the invention to provide a boat trailer modified as above in which the trolley has wheels that move inside the track and in which an encircling belt is connected to the trolley and the trolley is moved by transfer of torque from a hand-crank to the belt, which ultimately moves the trolley.

It is a further object of the invention to provide the above modified boat trailer in which the encircling belt is a timing belt.

It is a further object of the invention to provide a modified boat trailer as above which includes an automatic locking and releasing latch attached to the trolley.

It is a further object of the invention to provide a modified trailer as above in which the trolley includes a mast attached to and oriented at an angle from the top front surface of the trolley, and a mast receiver is provided that is permanently attached to the track and in which the mast fits inside the receiver and can be locked in place using an attachment pin when the boat is fully loaded onto the trailer.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of an improved boat trailer according to the present invention.

FIG. 2 is a partial side elevational view of the trolley and belt.

FIGS. 3A and 3B are, respectively, top plan and side elevational views of the track.

FIG. 4A is an enlarged scale side elevational view of the trolley. FIG. 4B is an enlarged scale cross-sectional view of the trolley in its track.

FIGS. 5A, 5B and 5C are respective end, top and perspective views of the docking plate.

FIGS. 6A and 6B are views showing operation of the latch.

FIG. 7 is a partial detail view of the hand crank and free tensioner.

FIG. 8 is a partial side elevational view of the trolley and belt according to a second embodiment of the present invention.

FIG. 9 is a partial detail view of the power winch and free tensioner.

Similar reference characters denote corresponding features consistently throughout the attached drawings.

### DETAILED DESCRIPTION OF THE PREFERRED EMBODIMENTS

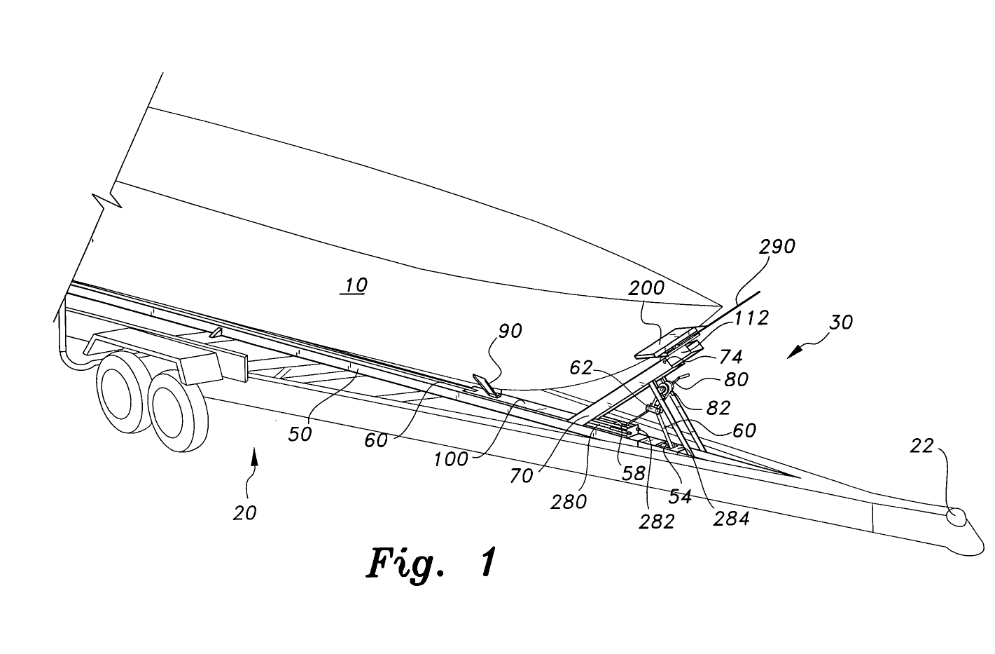

The present invention is directed to a modified boat trailer. FIG. 1 shows a boat 10 held in place in its fully loaded position on the trailer generally indicated at 20. Conventionally, boat trailers are built to fit a particular size boat. The present invention is an additional modification to permit the user to more easily load or launch the boat using a trolley and corresponding track.

When fully loaded, as shown in FIG. 1, the U-bolt normally located on the bow of the boat, i.e., the bow-mounted tow ring, is held in place by a latch situated behind docking plate 200. The aft of the boat is held in alignment on the trailer by rollers or bunks (not shown). The inventive load-bearing trolley 100 has a cushioning centering bar 90 that resiliently supports the front of the boat, and is movable along track 50 by moving a belt 60 with a hand-powered crank 80. The crank and supporting structure is generally indicated as item 30. At the front of the trailer is a conventional hitch 22.

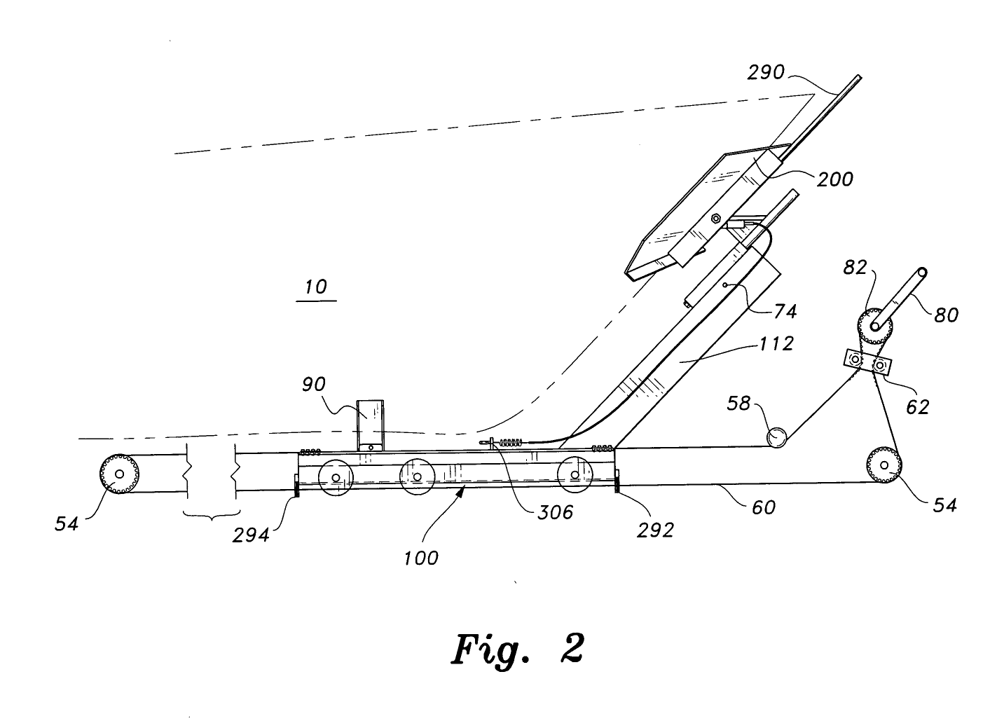

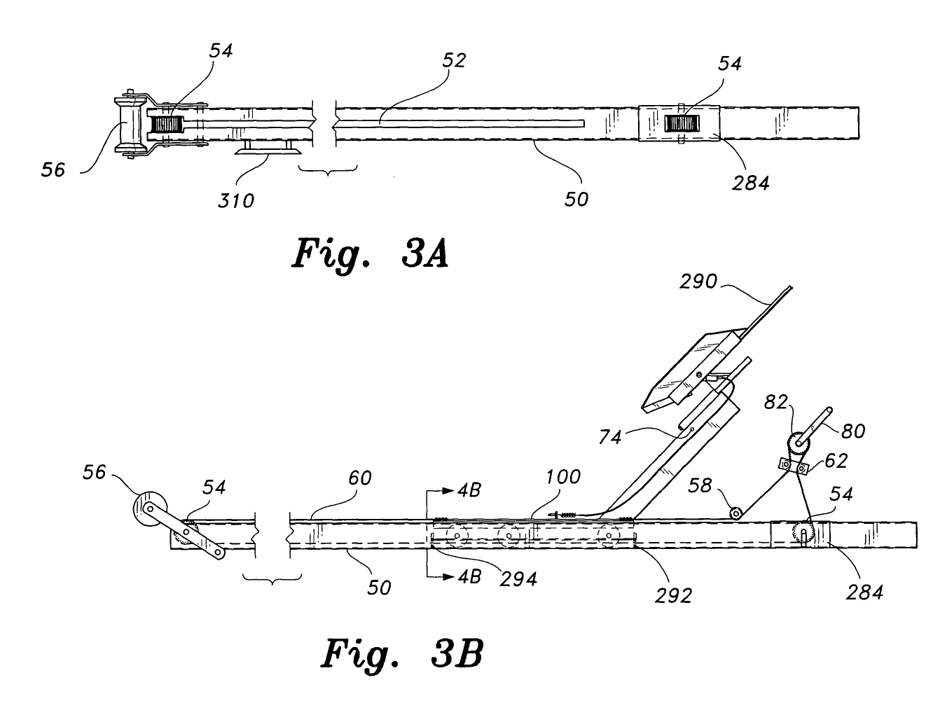

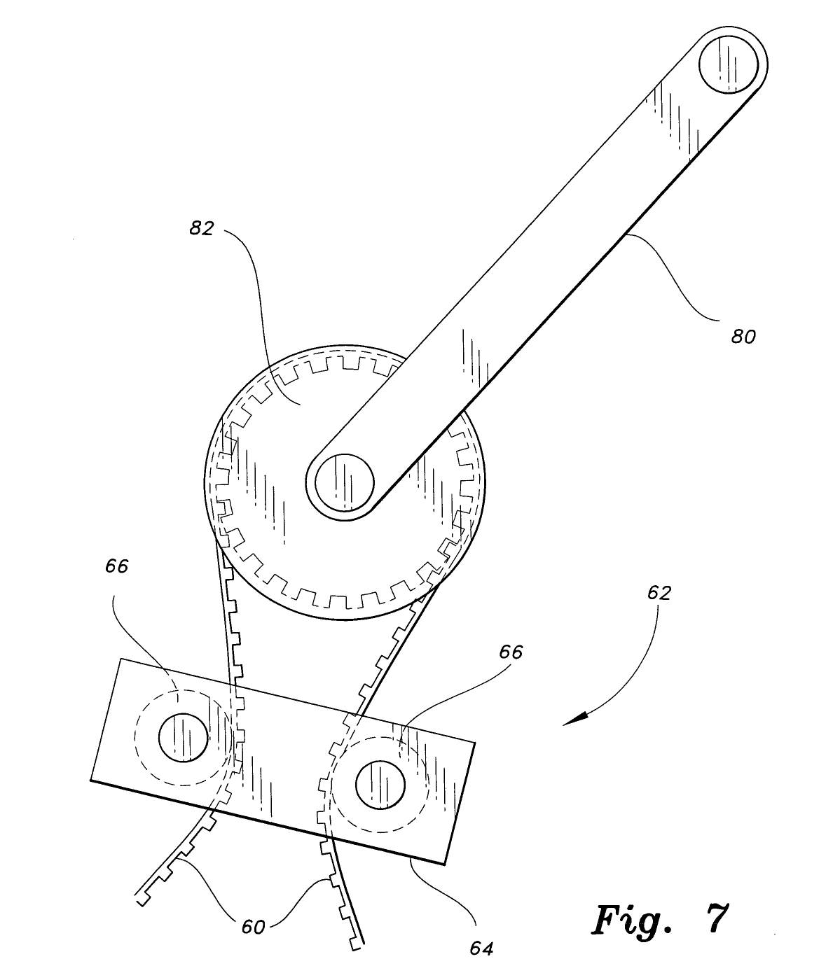

Belt strip 60 is held at its ends to the front and rear top edges of the trolley 100 and elsewhere by sprockets and idler rollers as explained as follows and shown in detail in FIGS. 2 and 3A-3B and in FIG. 7: beginning at the front of the trolley 100, belt 60 is fastened to the top front edge of the trolley; it then passes underneath an idler roller 58; through the free floating tensioner 62; around hand crank sprocket 82; passes again through the tensioner; around sprockets 54; and, finally, is fastened again at its opposite end to the rear top edge of the trolley 100.

Where the belt passes directly between the two sprockets 54, it passes through the inside channel of the track between the lower portions of the left and right wheels of the trolley. Where the belt emerges out from inside the track around the stern sprocket 54, it moves directly over the length of the slot 52 in the track along which the body of the trolley moves. This covering relationship of the belt over the slot helps to prevent debris from entering the inside of the track.

At the front of the trolley 100, a mast 112 is attached to its top surface, e.g., by welding. In the fully loaded position of FIG. 1, the trolley mast 112 is seated inside mast receiver 70, which is permanently attached to the track. Holes 74 are provided in the mast 112 and the mast receiver 70 that allow an attachment to be inserted and held in place with keeper pins, to ensure that the fully loaded boat is securely held in place on the trailer.

The track also provides support for the hand crank 30 that is operated with the handle and arm 80 to the move the trolley through the belt 60. When the hand crank 80 is turned, it transfers torque to the belt 60, causing it to move the trolley along the track 50. In FIG. 3B, sprocket 82 and idler roller 58 are free to rotate, but are permanently held at the ends of their axles to the track 50 by support braces (not shown).

Idler roller 58 is adjustable horizontally to take up any slack from the belt when the trolley 100 and belt 60 are first assembled into the track. Adjustment bolts 282 are used to adjust the position of the ends of the axle of roller 58 back-and-forth along a slot 280.

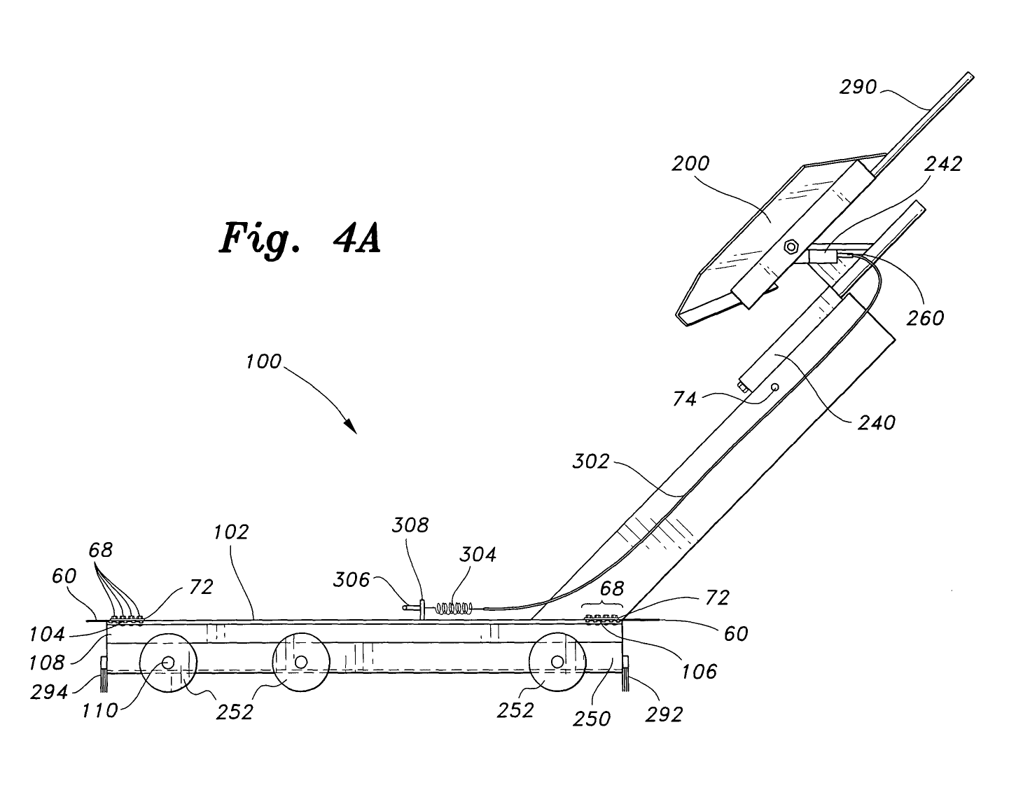

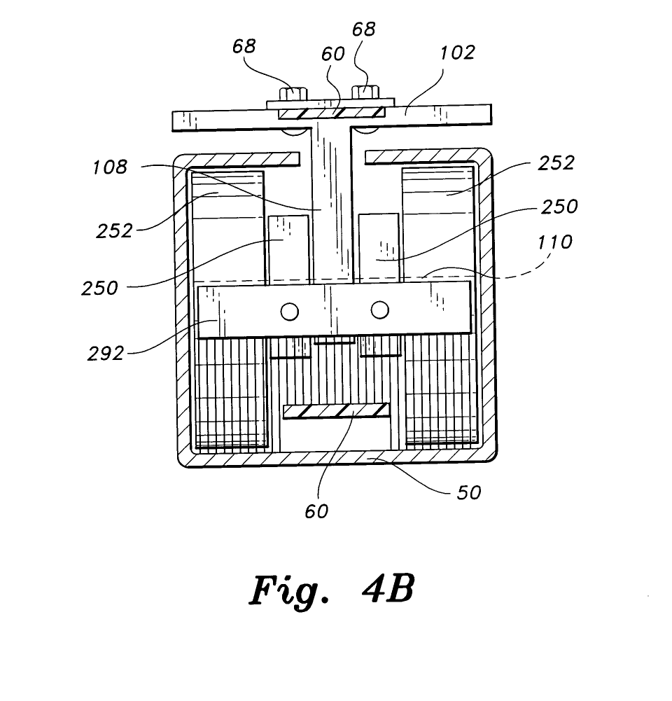

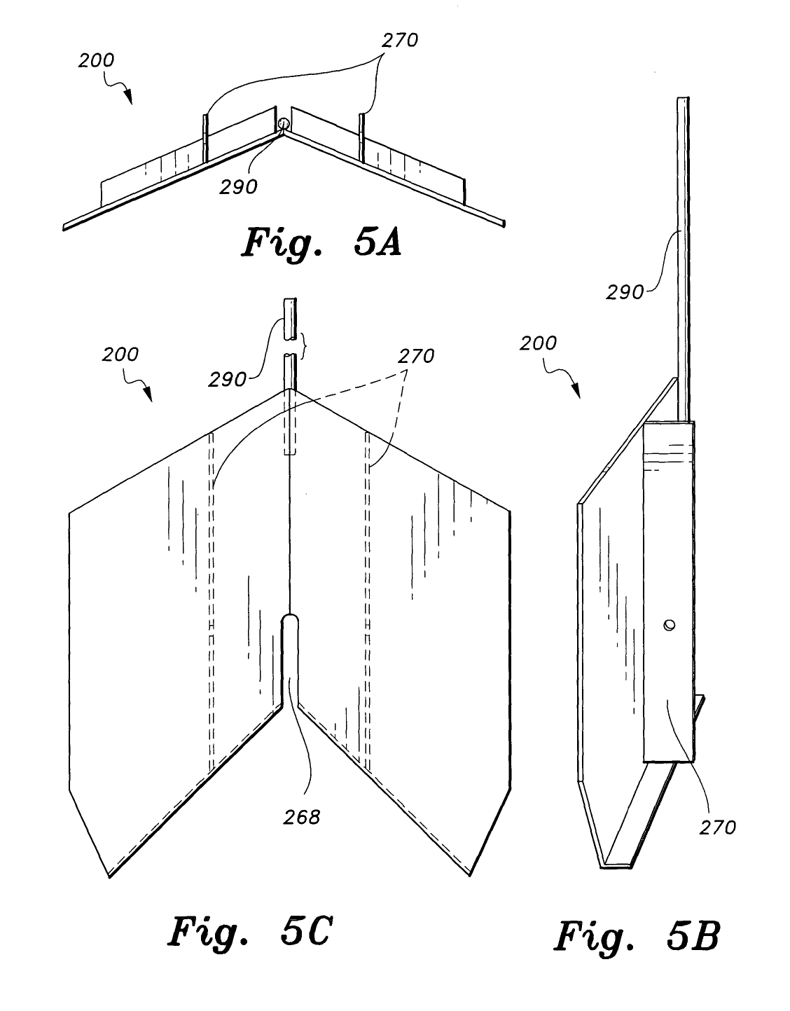

FIG. 4A shows details of the trolley 100. The docking plate 200 is attached,to the upper portion of the mast 112. Details of the docking plate are shown in FIGS. 5A-5C. The docking plate is held by back supports 270 on a pair of pivots that move on both a horizontal axis (shown as pivot 242) as well as a vertical axis 240. The aperture 268 in the lower portion of the docking plate receives the bow ring 230 during docking. A flexible target antenna 290 attached to the docking plate 200 allows the occupant of the boat to see the position of the docking plate/trolley when loading and to aim the boat properly to ensure that the tow ring enters the latch.

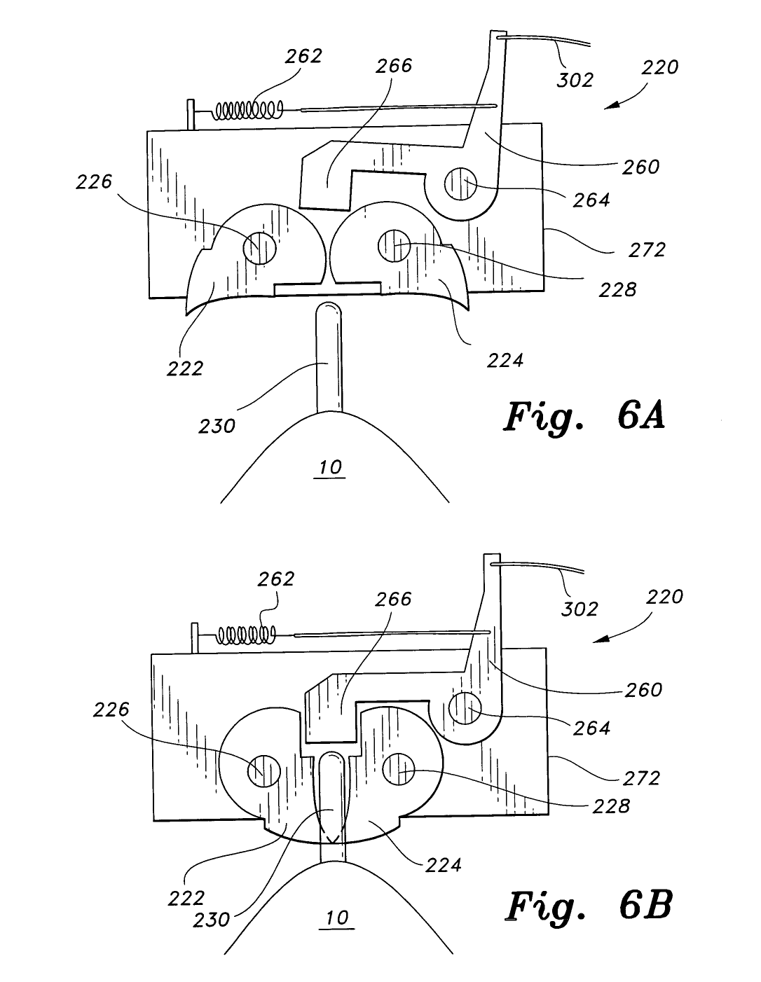

Immediately behind the bow ring receiving aperture 268 in the docking plate is a latch housing 272 containing a latch, which is shown in detail in FIGS. 6A-6B. The release cable 302 is attached at one end to the latch lever 260 and at the other end to the release lever 306. The release lever 306 moves back-and-forth on pivot 308. A tension spring 304 allows the lever to pivot without unduly stretching the cable. The release lever pivot 308 is attached to the top surface 102 of the trolley.

When the trolley is cranked to the stern end of the track 50, during launching or in preparing to load the boat onto the trolley 100, the release lever bar 310 actuates the release lever 306 on the trolley 100, causing the latch jaws 222 and 224 to open. When the boat is being launched, this causes the boat to be released from the trolley. Similarly, when the trolley is being placed into position to load the boat, the latch opens ready to receive the bow ring 230.

Free floating tensioner 62 is shown in detail in FIG. 7. Idler rollers 66 inside the tensioner housing 64 maintain a fixed spacing between the two moving portions of the belt 60 to take up slack.

At the front and rear edges of the trolley, the ends, 104 and 106, of a timing belt 60 are attached and held in place using a plate 72 and bolts 68 that pass through the plate, the belt end and the trolley surface. The ribs of the timing belt are shown in the cross-sectional view of FIG. 4A. Also, debris scrapers 292 and 294 are attached to the ends of the trolley that wipe debris inside the track to the ends of the track as the trolley moves. A detailed view of one of the brushes 292 is shown in FIG. 4B. The lower middle portion of the brushes is notched to permit sufficient space for the belt 60 to move freely beneath the brushes. FIG. 3B shows rubber roller 56 that is used to protect the rear of the track and the rear sprocket against damage as may occur, for example, when transporting the trailer.

As shown in FIGS. 4A and 4B, the top surface of the trolley 102 is attached to the vertical body 108 of the trolley, e.g., by welding. The body of the trolley includes six wheels 252 that rotate on axles 110. Between the trolley body 108 and the wheels 252 are spacers 250. The height of the wheels and the width of the axles are accommodated with a narrow tolerance within the channel of the track 50. A lubricant can be applied in the channel, if necessary.

In FIGS. 6A-6B, details are shown of the latch structure. Immediately prior to docking, the trolley is positioned at the stern end of the track and the bow ring 230 of the boat 10 approaches the docking plate. The latch 220 at this point is in its fully open position as shown in FIG. 6A. The boat 10 moves at approximately 1-3 knots toward the docking plate, as the bow ring enters the opening in the docking plate (see item 268 in FIG. 5C), it impinges on the latch jaws, 222 and 224, that rotate on respective pivots, 226 and 228, forcing the jaws to close into the position shown in FIG. 6B.

The normally open latch is now closed onto the bow ring 230, holding the bow of the boat 10 securely on the trolley 100. In the closed position, the latch lever 260 moves on pivot 264 to cause the end 266 of the latch lever to move into the notched portions of the jaws 224 and 226 to maintain the latch in the closed position. A spring 262 maintains the latch lever 260 in the position shown in FIG. 6B until the release lever is actuated when the boat is being launched.

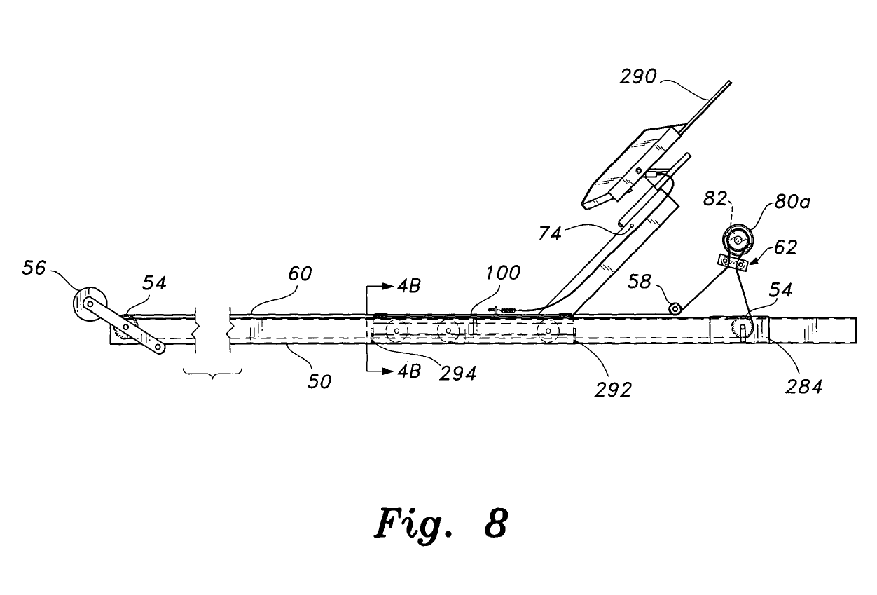

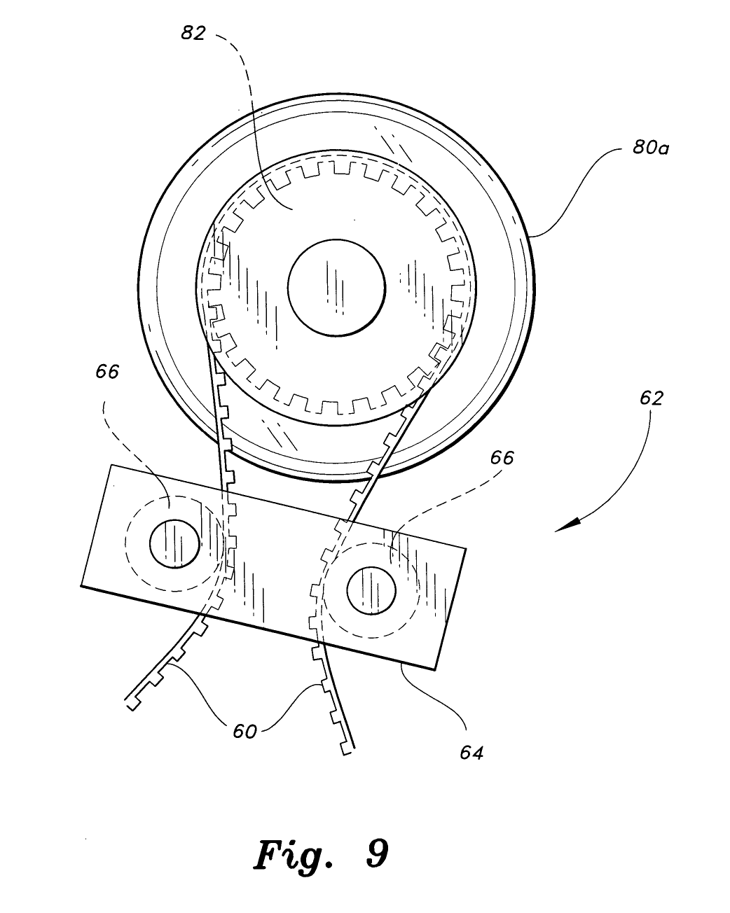

FIG. 8 depicts an additional embodiment of the present invention. In the embodiment depicted in FIG. 8 the hand crank 80 is replaced with a 12 volt DC power winch 80a. The power winch 80a allows the trolley 100 to be automatically moved. FIG. 9 shows an enlarged view of power winch 80a. The power winch 80a is secured to the sprocket 82 above the free tensioner 62.

Exemplary dimensions for a trailer capable of holding any trailerable boat are as follows. The track can be made of 3-inch box steel having a ⅝″ slot. The trolley can be made with a horizontal top steel strip having a 0.186″ thickness welded to a vertical body having a 0.375″ thickness. The length of the trolley can be 24″. The axles holding pairs of corresponding wheels onto the trolley are 0.75″ in diameter. The wheels can be made of nylon and have a diameter of 2.625″, sufficient to fit within the channel of the track while maintaining a small tolerance to permit movement along the track.

The timing belt can be L-100 and the two lower sprockets can be made of polycarbonate and designated as 24L-100, i.e., corresponding to 1″ width and capable of 400 lb load tension. The hand crank can be a forward-reverse “clicker” having a 3″ diameter L-100 timing pulley. The centering saddle on the trolley can be a rubber U-channel cut and held onto the trolley using bolts.

Although dimensions and materials have been provided for an exemplary structure, alternative materials and timing belts are also contemplated. For example, in order to load or launch larger boats, a wider track, trolley and timing belt would be required.

It is to be understood that the present invention is not limited to the embodiments described above, but encompasses any and all embodiments within the scope of the following claims.

We claim:

1. An improved boat trailer, comprising:
a boat support having a front end, a rear end and a plurality of trailer wheels disposed along the rear end;
a trailer hitch disposed on the front end of said boat support for releasably securing the trailer to a tow vehicle;
a linear track disposed along the center of said boat support having a front end, a back end and a belt receiving slot in the center of the track;
a load bearing vehicle movably disposed along said track, having a front edge, a rear edge and a top surface for receiving a boat;
a movement actuator for moving said load bearing vehicle along said track, having a first end and a second end, whereby the first end is secured to the front edge of said vehicle and the second end is secured to the rear edge of said vehicle; and
a crank in contact with the movement actuator, whereby the crank causes the movement actuator to move and, thereby, causes said load bearing vehicle to move along the track.

2. The boat trailer according to claim 1, wherein the load bearing vehicle comprises:
a mast receiver fixedly secured to the top surface of said load bearing vehicle, having an open top end adapted for receiving a mast and a plurality of fastener receiving holes for securing a mast inside of said mast receiver;
a mast, releasably secured inside of said mast receiver;
a docking plate disposed along the top of the mast for receiving a bow ring of the boat being positioned on the trailer;
a latch housing for securing the bow ring to the trailer;
a latch release mechanism;
a centering bar for supporting the front end of the boat being positioned on the trailer; and
a plurality of wheel assemblies for allowing the load bearing vehicle to move along said track.

3. The boat trailer according to claim 1, wherein said crank is selected from the group consisting of a rotating hand crank having a crank handle rotatably secured to a crank sprocket and a power winch secured to a sprocket.

4. The boat trailer according to claim 3, wherein said movement actuator comprises:
a timing belt strip having a first end and a second end;
an idler roller;
a tensioning device for maintaining a fixed spacing between the moving portions of the timing belt strip to take up slack in the belt strip; and
a plurality of sprockets;
whereby the first end of said timing belt strip is secured to the front edge of the load bearing vehicle, then passes underneath the idler roller, then through the tensioning device and around the sprocket of the crank, then passes back through the tensioning device and around the plurality of sprockets through the lower portion of the track, then moving directly over the slot in the track, and then the second end of said timing belt strip is secured to the rear edge of the load bearing vehicle.

5. The boat trailer according to claim 4, wherein said movement actuator further comprises a plurality of adjustment bolts and an adjustment slot for adjusting the idler roller to remove slack from the timing belt strip.

6. The boat trailer according to claim 2, wherein said docking plate comprises:
a main body having a right and a left portion;
a plurality of support rods, a first support rod being disposed through the right portion of the main body and a second support rod being disposed through the left portion of the main body, each of said support rods being mounted to the mast by a pivot;
an aperture disposed along the center of the main body between the right portion and the left portion for releasably receiving the bow ring of the boat during docking; and
a target antenna attached to the docking plate to allow the occupant of the boat to see the load bearing vehicle when loading the boat onto the trailer to ensure that the bow ring enters the aperture.

7. The boat trailer according to claim 6, wherein said latch housing is positioned behind the aperture of said docking plate, said latch housing comprising:
a latch having a pair of latch jaws for releasably engaging the bow ring of the boat;
a pair of jaw pivots for pivotally mounting the latch jaws to the latch housing; and
a lever for opening and closing said latch jaws;
whereby the bow ring of the boat enters into the aperture of the docking plate and engages the latch jaws that close around the bow ring.

8. The boat trailer according to claim 7, wherein said latch release mechanism further comprises:
a release lever;
a release lever pivot secured to the top surface of the load bearing vehicle;
a release cable, having a first end attached to the latch lever and a second end attached to the release lever; and
a tension spring for preventing undue stretching of the release cable;
wherein the release lever pivots back and forth about the release lever pivot and pulls the release cable, which then pulls the latch lever to release the bow ring from the latch jaws so that the boat may be removed from the trailer.

9. The boat trailer according to claim 1, further comprising a plurality of fasteners for securing said movement actuator to the load bearing vehicle.

10. The boat trailer according to claim 9, wherein said fasteners are fastening plates and bolts for securing said movement actuator to the load bearing vehicle.

11. The boat trailer according to claim 1, further comprising a plurality of debris scrapers disposed along the rear edge and the front edge of said load bearing vehicle for wiping debris from the track as the load bearing vehicle moves.

12. The boat trailer according to claim 1, further comprising a plurality of wheel assemblies disposed along the sides of the load bearing vehicle, said wheel assemblies comprising a plurality of axles secured to said vehicle, a plurality of wheels rotatably mounted to said axles and a plurality of spacers disposed between said wheels.

13. The boat trailer according to claim 1, further comprising a rubber roller disposed along the back end of the track for protecting the track against damage.

14. An improved boat trailer, the improvement comprising:
a load-bearing vehicle capable of supporting a boat, a linear track having a forward end and a rearward end, and movement actuator having two ends,
the load-bearing vehicle having an upper surface for supporting a boat, a front edge and a rear edge, the vehicle being movable along the track between the forward end and the rearward end;
the ends of the movement actuator attached to the front and rear edges of the vehicle, respectively; and
a crank in contact with the movement actuator, whereby the crank causes the movement actuator to move and, thereby, causes the load-bearing vehicle to move along the track.

15. An improved boat trailer, the improvement comprising:
a linear track disposed along the center of the trailer having a front end, a back end and a belt receiving slot in the center of the track;
a load bearing vehicle movably disposed along said track, having a front edge, a rear edge and a top surface for receiving a boat;
a movement actuator for moving said load bearing vehicle along said track, having a first end and a second end, whereby the first end is secured to the front edge of said vehicle and the second end is secured to the rear edge of said vehicle; and
a crank in contact with the movement actuator, whereby the crank causes the movement actuator to move and, thereby, causes said load bearing vehicle to move along the track.

16. The improvement according to claim 15, wherein the load bearing vehicle comprises:
a mast receiver fixedly secured to the top surface of said load bearing vehicle, having an open top end adapted for receiving a mast and a plurality of fastener receiving holes for securing a mast inside of said mast receiver;
a mast, releasably secured inside of said mast receiver;
a docking plate disposed along the top of the mast for receiving a bow ring of the boat being positioned on the trailer;
a latch housing for securing the bow ring to the trailer;
a latch release mechanism;
a centering bar for supporting the front end of the boat being positioned on the trailer; and
a plurality of wheels for allowing the load bearing vehicle to move along said track.

17. The improvement according to claim 15, wherein said crank is selected from the group consisting of a rotating hand crank having a crank handle rotatably secured to a crank sprocket and a power winch secured to a sprocket.

18. The improvement according to claim 17, wherein said movement actuator comprises:
a timing belt strip having a first end and a second end;
an idler roller;
a tensioning device for maintaining a fixed spacing between the moving portions of the timing belt strip to take up slack in the belt strip; and
a plurality of sprockets;
whereby the first end of said timing belt strip is secured to the front edge of the load bearing vehicle, then passes underneath the idler roller, then through the tensioning device and around the sprocket of the crank, then passes back through the tensioning device and around the plurality of sprockets through the lower portion of the track, then moving directly over the slot in the track, and then the second end of the said timing belt strip being secured to the rear edge of the load bearing vehicle.

19. The improvement according to claim 16, wherein said docking plate comprises:
a main body having a right and a left portion;
a plurality of support rods, a first support rod being disposed through the right portion of the main body and a second support rod being disposed through the left portion of the main body, each of said support rods being mounted to the mast by a pivot;
an aperture disposed along the center of the main body between the right portion and the left portion for releasably receiving the bow ring of the boat during docking; and
a target antenna attached to the docking plate to allow the occupant of the boat to see the load bearing vehicle when loading the boat onto the trailer to ensure that the bow ring enters the aperture.

20. The improvement according to claim 19, wherein said latch housing is positioned behind the aperture of said docking plate, said latch housing comprising:
a latch having a pair of latch jaws for releasably engaging the bow ring of the boat;
a pair of jaw pivots for pivotally mounting the latch jaws to the latch housing; and
a lever for opening and closing said latch jaws;
whereby the bow ring of the boat enters into the aperture of the docking plate and engages the latch jaws that close around the bow ring.
